(19) United States
(12) Patent Application Publication
(10) Pub. No.: US 2026/0016160 A1
(43) Pub. Date: Jan. 15, 2026

(54) METHOD AND SYSTEM FOR ADAPTIVE CONTROL OF GAS DEVICE FOR COMBUSTION APPLIANCES

(71) Applicant: Chant Heat Energy Science & Technology (Zhongshan) Co., Ltd., Zhongshan (CN)

(72) Inventors: Guoquan Chen, Zhongshan (CN); Jiaquan Deng, Zhongshan (CN); Xianmin Deng, Zhongshan (CN); Guangzhi Mai, Zhongshan (CN)

(21) Appl. No.: 18/948,461

(22) Filed: Nov. 14, 2024

(30) Foreign Application Priority Data
Jul. 10, 2024 (CN) 202410926340.0

(51) Int. Cl. F23K 5/00; G05B 13/02

(52) U.S. Cl. CPC F23K 5/005; G05B 13/024; F23K 2400/201

(57) ABSTRACT

Disclosed in the present disclosure is a method, an apparatus and a system for adaptive control of a gas device for combustion appliances. The multidimensional information corresponding to each of the combustion appliances, such as the type of each of the combustion appliances, the using object for each of the combustion appliances, and the ambient parameter in the space where each of the combustion appliances is located, are acquired automatically when it is detected that there are combustion appliances with gas combustion demands in a current time period are detected, a gas output control parameter for each of the combustion appliances is generated automatically according to the multidimensional information of all the combustion appliances, and the gas device is controlled to deliver the required gas to each of the combustion appliances according to the gas output control parameter corresponding to each of the combustion appliances.

### CROSS-REFERENCE TO RELATED APPLICATIONS

The present disclosure claims the priority of Chinese Patent Application No. 2024109263400 filed on Jul. 10, 2024 before CNIPA. All the above are hereby incorporated by reference in their entirety.

### TECHNICAL FIELD

The present disclosure relates to the technical field of control of gas devices, and particularly, to a method, an apparatus and a system for adaptive control of a gas device for combustion appliances.

### BACKGROUND

Combustion appliances that require the use of gas, such as gas stoves, water heaters, heaters, often exist in existing household device. It is necessary to control the use of gas for combustion appliances to ensure device and personnel safety based on the flammable and explosive properties of gas appliances.

In practice, when the combustion appliances need to be supplied with gas, the existing gas device is often adjusted directly through the gas regulator or the gas valve to change the gas delivery pressure of the gas delivery pipeline, so as to realize gas demands of the combustion appliances. However, it has been found in practice that the current way of gas adjustment by adjusting the gas regulator or the gas valve is inaccurate and cannot meet the combustion demands of the combustion appliances. Therefore, it is particularly important to propose a technical solution of how to improve the accuracy of the gas adjustment of the combustion appliances to improve the accuracy of gas distribution, so as to realize gas demands of the combustion appliances when the combustion appliances require gas.

### SUMMARY

The technical problem to be solved in the present disclosure is to provide a method, an apparatus and a system for adaptive control of a gas device for combustion appliances, which are capable of improving the accuracy of gas adjustment for combustion appliances to improve the accuracy of gas allocation, thus meeting combustion demands of combustion appliances.

In order to address the aforementioned technical problems, disclosed in a first aspect of the present disclosure is a method for adaptive control of the gas device for combustion appliances. The method is applied in a gas control system, the gas control system includes at least a control device, and the method includes:
acquiring, when it is detected that there are combustion appliances with gas combustion demands in a current time period, multidimensional information corresponding to each of the combustion appliances;
generating, according to the multidimensional information of all the combustion appliances, a gas output control parameter for each of the combustion appliances; and
controlling, according to the gas output control parameter corresponding to each of the combustion appliances, the gas device to deliver required gas to each of the combustion appliances.

As an optional implementation, in the first aspect of the present disclosure, the method further includes:
acquiring a current connection condition between each of the combustion appliances and the gas device, the current connection condition corresponding to each of the combustion appliances including at least one of a current gas condition in a gas delivery pipeline and a layout condition of the gas delivery pipeline, the current gas condition corresponding to each of the combustion appliances including at least one of a current gas flow rate and a current gas pressure, and the layout condition corresponding to each of the combustion appliances including at least one of a pipe diameter of the gas delivery pipeline and a bending condition of the gas delivery pipeline;
generating, according to the current connection condition corresponding to each of the combustion appliances, a control-parameter correcting parameter corresponding to each of the combustion appliances; and
correcting, for any one of the combustion appliances, the gas output control parameter for the combustion appliance to obtain the corrected gas output control parameter of the combustion appliance according to the control-parameter correcting parameter corresponding to the combustion appliance.

The controlling, according to the gas output control parameter corresponding to each of the combustion appliances, the gas device to deliver the required gas to each of the combustion appliances includes:
controlling, according to the corrected gas output control parameter corresponding to each of the combustion appliances, the gas device to deliver the required gas to each of the combustion appliances.

As an optional implementation, in the first aspect of the present disclosure, the method further includes:
collecting a correlation between at least two of all the combustion appliances; and
correcting, according to the association relationship between the at least two combustion appliances, the control-parameter correcting parameter corresponding to each of the combustion appliances to obtain the corrected control-parameter correcting parameter corresponding to each of the combustion appliances.

The correcting, for any one of the combustion appliances, the gas output control parameter for the combustion appliance to obtain the corrected gas output control parameter of the combustion appliance according to the control-parameter correcting parameter corresponding to the combustion appliance includes:
correcting, for any one of the combustion appliances, the gas output control parameter for the combustion appliance to obtain the corrected gas output control parameter of the combustion appliances according to the corrected control-parameter correcting parameter corresponding to the combustion appliance.

As an optional implementation, in the first aspect of the present disclosure, the generating, according to the multidimensional information of all the combustion appliances, the gas output control parameter for each of the combustion appliances includes:
determining, according to the multidimensional information of all the combustion appliances, gas consumption required for each of the combustion appliances in a unit time;
analyzing, according to the gas consumption required for each of the combustion appliances in the unit time, a gas delivery amount required for each of the combustion appliances in the unit time; and
generating, according to the gas delivery amount required for each of the combustion appliances in the unit time, the gas output control parameter for each of the combustion appliances.

As an optional implementation, in the first aspect of the present disclosure, the method further includes:
collecting, from the gas device, a gas supply amount in the unit time;
determining, according to the delivery amount required for each of the combustion appliances in the unit time, whether the gas supply amount of the gas device in the unit time meets gas demands of all the combustion appliances;
triggering, if a result is determined to be yes, the operation of generating, according to the gas delivery amount required for each of the combustion appliances in the unit time, the gas output control parameter for each of the combustion appliances to be performed; and
rectifying, if the result is determined to be no, the gas delivery amount required for each of the combustion appliances in the unit time to obtain the rectified gas delivery amount required for each of the combustion appliances in the unit time according to the gas supply amount of the gas device in the unit time.

The generating, according to the gas delivery amount required for each of the combustion appliances in the unit time, the gas output control parameter for each of the combustion appliances includes:
generating, according to the rectified gas delivery amount required for each of the combustion appliances in the unit time, the gas output control parameter for each of the combustion appliances.

As an optional implementation, in the first aspect of the present disclosure, the method further includes:
determining whether there exists in the current time period using requirement information triggered by one or more using objects corresponding to one or more of the all detected combustion appliances for a combustion appliance to be used;
triggering, if a result is determined to be no, the operation of analyzing, according to the gas consumption required for each of the combustion appliances in the unit time, the gas delivery amount required for each of the combustion appliances in the unit time to be performed;
analyzing, if the result is determined to be yes, an urgency degree of the gas demand corresponding to each of the one or more combustion appliances in the current time period according to the using requirement information corresponding to each of the one or more combustion appliances;
adjusting, according to the urgency degree of the gas demand corresponding to each of the one or more combustion appliances, the gas consumption required for each of the one or more combustion appliances in the unit time; and triggering the operation of analyzing, according to the gas consumption required for each of the one or more combustion appliances in the unit time, the gas delivery amount required for each of the one or more combustion appliances in the unit time to be performed.

As an optional implementation, in the first aspect of the present disclosure, for any one of the combustion appliances, the multidimensional information corresponding to the combustion appliance includes one or more of a type of the combustion appliance, a using requirement of a using object for the combustion appliance at the current time period, a location of the combustion appliance in a current scene, and an ambient parameter in a space where the combustion appliance is located;
the using requirement of the using object for the combustion appliance at the current time period includes one or more of a using function of the combustion appliance at the current time period, a using gear of the using function, and a using duration of the using function; and
the ambient parameter in the space where the combustion appliance is located includes one or more of ambient humidity, ambient temperature, and air flowing rate.

In a second aspect of the present disclosure, disclosed is an apparatus for adaptive control of the gas device for combustion appliances. The apparatus is applied in a gas control system, the gas control system includes at least a control device, and the apparatus includes:
an acquisition module, configured to acquire multidimensional information corresponding to each of the combustion appliances when it is detected that there are combustion appliances with gas combustion demands in a current time period;
a generating module, configured to generate a gas output control parameter for each of the combustion appliances according to the multidimensional information of all the combustion appliances; and
   a control module, configured to control the gas device to deliver the required gas to each of the combustion appliances according to the gas output control parameter corresponding to each of the combustion appliances.

As an optional implementation, in the second aspect of the present disclosure, acquisition module is further configured to acquire a current connection condition between each of the combustion appliances and the gas device. The current connection condition corresponding to each of the combustion appliances includes at least one of a current gas condition in a gas delivery pipeline and a layout condition of the gas delivery pipeline. The current gas condition corresponding to each of the combustion appliances includes at least one of a current gas flow rate and a current gas pressure. The layout condition corresponding to each of the combustion appliances includes at least one of a pipe diameter of the gas delivery pipeline and a bending condition of the gas delivery pipeline.

The generating module is further configured to generate a control-parameter correcting parameter corresponding to each of the combustion appliances according to the current connection condition corresponding to each of the combustion appliances.

The apparatus includes:
a correction module, for any one of the combustion appliances, configured to correct the gas output control parameter for the combustion appliance to obtain the corrected gas output control parameter of the combustion appliance according to the control-parameter correcting parameter corresponding to the combustion appliance.

A specific way of the control module controlling the gas device to deliver the required gas to each of the combustion appliances according to the gas output control parameter corresponding to each of the combustion appliances includes:
controlling, according to the corrected gas output control parameter corresponding to each of the combustion appliances, the gas device to deliver the required gas to each of the combustion appliances.

As an optional implementation, in the second aspect of the present disclosure, the apparatus further includes a collection module.

The collection module, configured to collect a correlation between at least two of all the combustion appliances; and

The correction module, configured to correct the control-parameter correcting parameter corresponding to each of the combustion appliances to obtain the corrected control-parameter correcting parameter corresponding to each of the combustion appliances according to the correlation between the at least two combustion appliances.

A specific way of the correction module, for any one of the combustion appliances, correcting the gas output control parameter for the combustion appliance to obtain the corrected gas output control parameter of the combustion appliance according to the control-parameter correcting parameter corresponding to the combustion appliance includes:
correcting, for any one of the combustion appliances, the gas output control parameter for the combustion appliance to obtain the corrected gas output control parameter of the combustion appliances according to the corrected control-parameter correcting parameter corresponding to the combustion appliance.

As an optional implementation, in the second aspect of the present disclosure, A specific way of the generating module generating the gas output control parameter for each of the combustion appliances according to the multidimensional information of all the combustion appliances includes:
determining, according to the multidimensional information of all the combustion appliances, gas consumption required for each of the combustion appliances in a unit time;
analyzing, according to the gas consumption required for each of the combustion appliances in the unit time, a gas delivery amount required for each of the combustion appliances in the unit time; and
generating, according to the gas delivery amount required for each of the combustion appliances in the unit time, the gas output control parameter for each of the combustion appliances.

As an optional implementation, in the second aspect of the present disclosure, The acquisition module is further configure to collect a gas supply amount in the unit time from the gas device.

The apparatus includes:
an analysis module, configured to determine whether the gas supply amount of the gas device in the unit time meets gas demands of all the combustion appliances according to the delivery amount required for each of the combustion appliances in the unit time, and to trigger the operation of generating, according to the gas delivery amount required for each of the combustion appliances in the unit time, the gas output control parameter for each of the combustion appliances to be performed if a result is determined to be yes; and
a rectify module, configured to rectify the gas delivery amount required for each of the combustion appliances in the unit time according to the gas supply amount of the gas device in the unit time to obtain the rectified gas delivery amount required for each of the combustion appliances in the unit time if the result is determined to be no.

A specific way of the generating module generating the gas output control parameter for each of the combustion appliances according to the gas delivery amount required for each of the combustion appliances in the unit time includes:
generating, according to the rectified gas delivery amount required for each of the combustion appliances in the unit time, the gas output control parameter for each of the combustion appliances.

As an optional implementation, in the second aspect of the present disclosure, the apparatus further includes a collection module.

The determining module is configured to determine whether there exists in the current time period using requirement information triggered by one or more using objects corresponding to one or more of the all detected combustion appliances for a combustion appliance to be used, and to trigger the operation of analyzing, according to the gas consumption required for each of the combustion appliances in the unit time, the gas delivery amount required for each of the combustion appliances in the unit time to be performed if a result is determined to be no.

The analysis module is further configured to analyze an urgency degree of the gas demand corresponding to each of the one or more combustion appliances in the current time period according to the using requirement information corresponding to each of the one or more combustion appliances if the result is determined to be yes.

The adjustment module is configured to adjust the gas consumption required for each of the one or more combustion appliances in the unit time according to the urgency degree of the gas demand corresponding to each of the one or more combustion appliances, and to trigger the analysis module to perform the operation of analyzing, according to the gas consumption required for each of the one or more combustion appliances in the unit time, the gas delivery amount required for each of the one or more combustion appliances in the unit time.

As an optional implementation, in the second aspect of the present disclosure, for any one of the combustion appliances, the multidimensional information corresponding to the combustion appliance includes one or more of a type of the combustion appliance, a using requirement of a using object for the combustion appliance at the current time period, a location of the combustion appliance in a current scene, and an ambient parameter in a space where the combustion appliance is located;
the using requirement of the using object for the combustion appliance at the current time period includes one or more of a using function of the combustion appliance at the current time period, a using gear of the using function, and a using duration of the using function; and
the ambient parameter in the space where the combustion appliance is located includes one or more of ambient humidity, ambient temperature, and air flowing rate.

In a third aspect of the present disclosure, disclosed is an apparatus for adaptive control of a gas device for combustion appliances. the apparatus is applied in a gas control system, the gas control system includes at least a control device, and the control device includes:
a memory, memorized with an executable code; and
a processor, coupled with the memory.

The processor invokes the executable code memorized in the memory to perform the method for adaptive control of the gas device for combustion appliances disclosed in the first aspect of the present disclosure.

In a fourth aspect of the present disclosure, disclosed is a non-transitory computer readable memory medium. the non-transitory computer readable memory medium memorizes computer instructions, and the computer instructions, when invoked, are configured to cause the method for adaptive control of the gas device for combustion appliances disclosed in the first aspect of the present disclosure.

Compared to the prior art, the embodiments of the present disclosure have beneficial effects as follows:
In the embodiments of the present disclosure, the multidimensional information corresponding to each of the combustion appliances, such as the type of each of the combustion appliances, the using object for each of the combustion appliances, and the ambient parameter in the space where each of the combustion appliances is located, are acquired automatically when it is detected that there are combustion appliances with gas combustion demands in a current time period, a gas output control parameter for each of the combustion appliances is generated automatically according to the multidimensional information of all the combustion appliances, and the gas device is controlled to deliver the required gas to each of the combustion appliances according to the gas output control parameter corresponding to each of the combustion appliances.

In this way, it is capable of improving the accuracy of gas adjustment for the combustion appliances to improve the accuracy of gas allocation, thereby meeting combustion demands of the combustion appliances and ensuring the safety of the gas device, the combustion appliances and other objects and people in the space where the combustion appliances are located.

### BRIEF DESCRIPTION OF THE DRAWINGS

In order to illustrate the technical solutions of the embodiments of the present disclosure more clearly, the following drawings are briefly described as required in the context of the embodiments. Obviously, the following drawings illustrate only some of the embodiments of the present disclosure. Other relevant drawings may be obtained on the basis of these drawings without any creative effort by those skilled in the art.

FIG. 1 is a schematic flow diagram of a method for adaptive control of a gas device for combustion appliances disclosed in an embodiment of the present disclosure;

FIG. 2 is a schematic flow diagram of another method for adaptive control of a gas device for combustion appliances disclosed in an embodiment of the present disclosure;

FIG. 3 is a schematic structural diagram of an apparatus for adaptive control of a gas device for combustion appliances disclosed in an embodiment of the present disclosure;

FIG. 4 is a schematic structural diagram of another apparatus for adaptive control of a gas device for combustion appliances disclosed in an embodiment of the present disclosure; and

FIG. 5 is a schematic structural diagram of a gas control system disclosed in an embodiment of the present disclosure.

### DETAILED DESCRIPTION

For a better understanding of the solutions of the present disclosure by those skilled in the art, the technical solutions in the embodiments of the present disclosure are clearly and completely described and discussed below in conjunction with the attached drawings of the embodiments of the present disclosure. Obviously, the embodiments described herein are only some of the embodiments of the present disclosure but not all of them. Based on the embodiments in the present disclosure, all other embodiments obtained by those skilled in the art without inventive effort fall within the scope of protection of the present disclosure.

The terms “first”, “second”, and the like in the specification, the claims and the above-mentioned drawings of the present disclosure are used to identify different objects and are not intended to describe a particular sequence. Additionally, the terms “comprise” and “include”, and any derivatives and conjugations thereof, are intended to cover non-exclusive inclusion. For example, a process, method, apparatus, product, or device that includes a series of steps or units is not limited to the listed steps or units, but optionally also includes steps or units that are not listed, or optionally also includes other steps or units that are inherent to those processes, methods, products, or devices.

The term “embodiment” herein means that a particular feature, structure or characteristic described in conjunction with an embodiment may be included in at least one embodiment of the present application. The presence of the term in various places in the specification does not necessarily indicate the same embodiment, nor is it a separate or alternative embodiment that is mutually exclusive with other embodiments. It is understood, both explicitly and implicitly, by those skilled in the art that the embodiments described herein may be combined with other embodiments.

Disclosed in the present disclosure is a method, an apparatus and a system for adaptive control of a gas device for combustion appliances. The multidimensional information corresponding to each of the combustion appliances, such as the type of each of the combustion appliances, the using object for each of the combustion appliances, and the ambient parameter in the space where each of the combustion appliances is located, is acquired automatically when it is detected that there are combustion appliances with gas combustion demands in a current time period, a gas output control parameter for each of the combustion appliances is generated automatically according to the multidimensional information of all the combustion appliances, and the gas device is controlled to deliver the required gas to each of the combustion appliances according to the gas output control parameter corresponding to each of the combustion appliances.

In this way, it is capable of improving the accuracy of gas adjustment for the combustion appliances to improve the accuracy of gas allocation, thereby meeting combustion demands of the combustion appliances and ensuring the safety of the gas device, the combustion appliances and other objects and people in the space where the combustion appliances are located. The method, the apparatus and the system for adaptive control of the gas device for the combustion appliances are described in detail below.

### First Embodiment

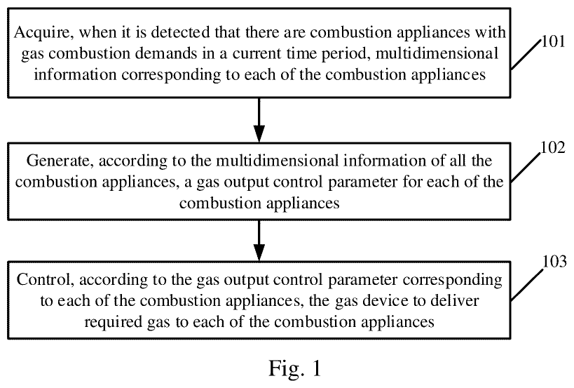

Referring to FIG. 1, FIG. 1 is a schematic flow diagram of a method for adaptive control of a gas device for combustion appliances disclosed in an embodiment of the present disclosure. The method for adaptive control of the gas device for combustion appliances illustrated in FIG. 1 may be implemented by means of an apparatus for adaptive control. The apparatus for adaptive control is applied in a gas control system. The gas control system includes a control device, combustion appliances and a gas device. The control device is in communication connection with the gas device and each of the combustion appliances, respectively, the gas device is connected to each of the combustion appliances through a gas delivery pipeline, and the gas delivery pipeline corresponding to each of the combustion appliances is configured to deliver gas from the gas device to the corresponding combustion appliance. As shown in FIG. 1, the method for adaptive control of the gas device for combustion appliances may include the following steps.

In step 101, multidimensional information corresponding to each of the combustion appliances is acquired when it is detected that there are combustion appliances with gas combustion demands in a current time period.

In the embodiment of the present disclosure, optionally, for any one of the combustion appliances, the multidimensional information corresponding to the combustion appliance includes one or more of a type of the combustion appliance, a using requirement of a using object for the combustion appliance at the current time period, a location of the combustion appliance in a current scene, and an ambient parameter in a space where the combustion appliance is located. The using requirement of the using object for the combustion appliance at the current time period includes one or more of a using function, such as a stir-fry function, and a steaming function of a cooking cookware, of the combustion appliance at the current time period, a using gear, such as a first gear, and a second gear, of the using function, and a using duration of the using function. The ambient parameter in the space where the combustion appliance is located includes one or more of ambient humidity, ambient temperature, and air flowing rate. The type of the combustion appliance includes, but is not limited to, one of any type of appliance that requires the use of gas, such as a heating type (e.g., a heater), a cooking type (e.g., a cooking cookware), and a hot water type (e.g., a water heater). It should be noted that the combustion appliances may be understood as none of the appliances being in working condition, or all of the appliances being in working condition, or some of the appliances not being in working condition and some of the appliances being in working condition.

In step 102, a gas output control parameter for each of the combustion appliances is generated according to the multidimensional information of all the combustion appliances.

In the embodiment of the present disclosure, optionally, the gas output control parameter corresponding to each of the combustion appliances includes at least one of a gas output control pressure and a gas output control flow rate. Optionally, the gas output control parameter corresponding to each of the combustion appliances may further includes a gas output control temperature.

In step 103, the gas device is controlled to deliver the required gas to each of the combustion appliances according to the gas output control parameter corresponding to each of the combustion appliances.

In the embodiment of the present disclosure, specifically, for each of the combustion appliances, a gas control valve may be provided between the combustion appliance and the gas device, and the gas device may be controlled to deliver the required gas by controlling the gas control valve.

In the embodiment of the present disclosure, the gas includes, but is not limited to, one of natural gas, artificial gas, biogas, liquefied petroleum gas, and the like that can be delivered through the gas delivery pipeline.

Evidently, the method in the embodiments of the present disclosure is implemented in a way that the multidimensional information corresponding to each of the combustion appliances, such as the type of each of the combustion appliances, the using object for each of the combustion appliances, and the ambient parameter in the space where each of the combustion appliances is located, are acquired automatically when it is detected that there are combustion appliances with gas combustion demands in a current time period, a gas output control parameter for each of the combustion appliances is generated automatically according to the multidimensional information of all the combustion appliances, and the gas device is controlled to deliver the required gas to each of the combustion appliances according to the gas output control parameter corresponding to each of the combustion appliances. In this way, it is capable of improving the accuracy of gas adjustment for the combustion appliances to improve the accuracy of gas allocation, thereby meeting combustion demands of the combustion appliances and ensuring the safety of the gas device, the combustion appliances and other objects and people in the space where the combustion appliances are located.

In the embodiment of the present disclosure, optionally, the gas output control parameter for each of the combustion appliances being generated according to the multidimensional information of all the combustion appliances includes the following steps:
gas consumption required for each of the combustion appliances in a unit time is determined according to the multidimensional information of all the combustion appliances;
a gas delivery amount required for each of the combustion appliances in the unit time is analyzed according to the gas consumption required for each of the combustion appliances in the unit time; and
the gas output control parameter for each of the combustion appliances is generated according to the gas delivery amount required for each of the combustion appliances in the unit time.

Evidently, in the optional embodiment, the gas consumption required for each of the combustion appliances in the unit time is determined according to the multidimensional information of each of the combustion appliances, then the gas delivery amount required for each of the combustion appliances in the unit time is determined, and then the corresponding gas output control parameter is generated. Therefore, it is capable of improving the accuracy and reliability of the generation of the gas output control parameter.

In an optional implementation, the method may further include the following steps:
a gas supply amount in the unit time is collected from the gas device;
whether the gas supply amount of the gas device in the unit time meets gas demands of all the combustion appliances is determined according to the delivery amount required for each of the combustion appliances in the unit time;
the above operation of the gas output control parameter for each of the combustion appliances being generated according to the gas delivery amount required for each of the combustion appliances in the unit time is triggered to be performed if a result is determined to be yes; and
the gas delivery amount required for each of the combustion appliances in the unit time is rectified to obtain the rectified gas delivery amount required for each of the combustion appliances in the unit time according to the gas supply amount of the gas device in the unit time if the result is determined to be no.

The gas output control parameter for each of the combustion appliances being generated according to the gas delivery amount required for each of the combustion appliances in the unit time includes the following step:
the gas output control parameter for each of the combustion appliances is generated according to the rectified gas delivery amount required for each of the combustion appliances in the unit time.

In the optional embodiment, optionally, the sum of the gas delivery amounts required for all combustion appliances in the unit time is calculated. It is determined that the gas demand of all the combustion appliances is met if the gas supply amount from the gas appliance in the unit time is greater than the sum of the gas deliveries, otherwise, it is determined that the gas demand of all the combustion appliances is not met.

In the optional embodiment, optionally, the gas delivery amount required for each of the combustion appliances in the unit time being rectified to obtain the rectified gas delivery amount required for each of the combustion appliances in the unit time according to the gas supply amount of the gas device in the unit time includes: calculating a gas difference between the sum of the gas delivery amounts required for all the combustion appliances and the gas supply amount, calculating a combustion delivery amount ratio between all the combustion appliances according to the gas delivery amounts required for all combustion appliances, and correcting the gas delivery amount required for each of the combustion appliances in the unit of time according to the combustion delivery amount ratio and the gas difference.

Evidently, in the optional embodiment, the corresponding gas output control parameter is generated only if it is determined that the gas supply of the gas device meets the gas demand of all the combustion appliances, and the gas delivery amount required for the combustion appliances is corrected to generate the corresponding gas output control parameter based on the gas supply volume if it is determined that the gas supply of the gas device does not meet the gas demand of all the combustion appliance. Therefore, it is capable of improving the accuracy of the generation of the gas output control parameters corresponding to all the combustion appliances, and even in a case of insufficient gas supply, it is capable of realizing the accurate allocation of gas supply, which is conducive to improving the accuracy of gas supply for each of the combustion appliances and meeting the gas demand of different combustion appliances. In addition, the gas delivery amount required for each combustion appliance is corrected by the gas difference between the sum of the gas delivery amounts required for all combustion appliances and the gas supply amount and the combustion delivery amount ratio between all the combustion appliances, which is capable of improving the allocation accuracy of the gas delivery amount required for all combustion appliances, thereby improving their delivery accuracy.

In another optional embodiment, the method may further include the followings steps:
whether it is determined that there exists, in the current time period, using requirement information triggered by one or more using objects corresponding to one or more of the all detected combustion appliances for a combustion appliance to be used;
The above operation of the gas delivery amount required for each of the combustion appliances in the unit time being analyzed according to the gas consumption required for each of the combustion appliances in the unit time is triggered to be performed if a result is determined to be no;
an urgency degree of the gas demand corresponding to each of the one or more combustion appliances in the current time period is analyzed according to the using requirement information corresponding to each of the one or more combustion appliances if the result is determined to be yes;
the gas consumption required for each of the one or more combustion appliances in the unit time is adjusted according to the urgency degree of the gas demand corresponding to each of the one or more combustion appliances; and the above operation of the gas delivery amount required for each of the one or more combustion appliances in the unit time being analyzed according to the gas consumption required for each of the one or more combustion appliances in the unit time is triggered to be performed.

In the optional embodiment, for any one of the combustion appliances, the corresponding using demand information may be triggered by a voice input by the corresponding using object, or may be triggered by a text input by the corresponding using object, or may be triggered by a combination of both. Further and optionally, for the combustion appliance with a higher urgency degree of the gas demand, the gas consumption required for it in the unit time, on the premise of ensuring its safety, is increased, and the gas delivery amount required for it in the unit time is increased correspondingly, or priority is given to delivering gas to it.

Evidently, in the optional embodiment, whether the using requirement information triggered by the using object of the corresponding combustion appliance is received, and then the gas delivery amount required for the combustion appliance in the unit time is continuing to be analyzed if not, otherwise the using requirement information triggered by the using object of the combustion appliance is analyzed and the gas delivery amount required for the combustion appliance is adjusted according to the analyzed urgency degree of the gas demand. In this way, it is capable of meeting the gas demand of the corresponding using object while improving the accuracy of determining the gas consumption required for each of the combustion appliances, thus improving the user's gas experience.

In yet another optional embodiment, the method may further include the followings steps:
a gas using period type to which a current time period belongs is determined if it is determined that there is no using requirement information triggered by the using object corresponding to the one or more of the all detected combustion appliances for a combustion appliance to be used;
the operation of analyzing, according to the gas consumption required for each of the combustion appliances in the unit time, the gas delivery amount required for each of the combustion appliances in the unit time to be performed is triggered if the gas using period type to which the current time period belongs is configured to indicate a time period in which the gas consumption of them is less than the preset gas consumption;
the historical gas consumption for each of the combustion appliances in a historical time period on every day of the past multiple days that corresponds to, i.e., is the same as or overlaps with, the current time period is acquired if the gas using period type to which the current time period belongs is configured to indicate a time period in which the gas consumption of them is greater than or equal to the preset gas consumption;
for any one of the combustion appliances, the sum of its corresponding historical gas consumption for each day of the past multiple days is calculated, and the sum of the historical gas consumption is divided by the corresponding days to obtain the historical average gas consumption, and a consumption difference between the historical average gas consumption and the preset gas consumption is calculated; and
the gas consumption required for each of the combustion appliances in the unit time is adjusted according to the consumption difference corresponding to each of the combustion appliances; and the operation of analyzing, according to the gas consumption required for each of the combustion appliances in the unit time, the gas delivery amount required for each of the combustion appliances in the unit time is triggered to be performed.

Evidently, in the optional embodiment, the aforementioned gas consumption analyzed according to the multidimensional information of the combustion appliance is adjusted automatically by acquiring its historical gas consumption in the time period on every day of the past multiple days that corresponding to the current time period if it is determined that the corresponding using requirement information is not detected in the current time period, so that it is capable of further improving the analysis accuracy of the gas consumption required for each of the combustion appliances, thereby facilitating further improving the analysis accuracy of the gas delivery amount required for each of the combustion appliances, which in turn is conducive to improving the accuracy of the generation of the corresponding gas output control parameter, and improving the allocation and delivery accuracy of the gas.

### Second Embodiment

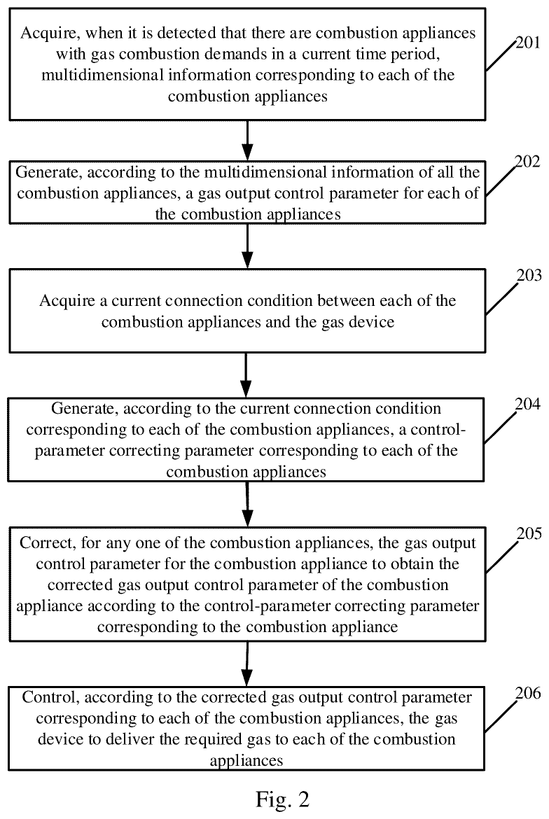

Referring to FIG. 2, FIG. 2 is a schematic flow diagram of another method for adaptive control of a gas device for combustion appliances disclosed in an embodiment of the present disclosure. The method for adaptive control of the gas device for combustion appliances illustrated in FIG. 2 may be implemented by means of an apparatus for adaptive control. The apparatus for adaptive control is applied in a gas control system. The gas control system includes a control device, combustion appliances and a gas device. The control device is in communication connection with the gas device and each of the combustion appliances, respectively, the gas device is connected to each of the combustion appliances through a gas delivery pipeline, and the gas delivery pipeline corresponding to each of the combustion appliances is configured to deliver gas from the gas device to the corresponding combustion appliance. As shown in FIG. 2, the method for adaptive control of the gas device for combustion appliances may include the following steps.

In step 201, multidimensional information corresponding to each of the combustion appliances is acquired when it is detected that there are combustion appliances with gas combustion demands in a current time period.

In step 202, a gas output control parameter for each of the combustion appliances is generated according to the multidimensional information of all the combustion appliances.

In step 203, a current connection condition between each of the combustion appliances and the gas device is acquired.

In the embodiment of the present disclosure, optionally, the current connection condition corresponding to each of the combustion appliances includes at least one of a current gas condition in a gas delivery pipeline and a layout condition of the gas delivery pipeline, the current gas condition corresponding to each of the combustion appliances includes at least one of a current gas flow rate and a current gas pressure, and the layout condition corresponding to each of the combustion appliances includes at least one of a pipe diameter of the gas delivery pipeline and a bending condition of the gas delivery pipeline.

In step 204, a control-parameter correcting parameter corresponding to each of the combustion appliances is generated according to the current connection condition corresponding to each of the combustion appliances.

In step 205, for any one of the combustion appliances, the gas output control parameter for the combustion appliance is corrected to obtain the corrected gas output control parameter of the combustion appliance according to the control-parameter correcting parameter corresponding to the combustion appliance.

In step 206, the gas device is controlled to deliver the required gas to each of the combustion appliances according to the corrected gas output control parameter corresponding to each of the combustion appliances.

It should be noted that other related descriptions of steps 202 to 206 may be found with reference to the other detailed descriptions of steps 101 to 103 in the first embodiment, and are not repeated in the present embodiment of the disclosure. It should also be noted that steps 203 and 204 may be performed simultaneously with step 201 of acquiring the multidimensional information corresponding to each of the combustion appliances or with step 202, or may be performed prior to step 201 of acquiring the multidimensional information corresponding to each of the combustion appliances or may be performed between step 201 and step 202, which is not limited in the present disclosure.

Evidently, the method in the embodiments of the present disclosure is implemented in a way that the multidimensional information corresponding to each of the combustion appliances, such as the type of each of the combustion appliances, the using object for each of the combustion appliances, and the ambient parameter in the space where each of the combustion appliances is located, are acquired automatically when it is detected that there are combustion appliances with gas combustion demands in a current time period, a gas output control parameter for each of the combustion appliances is generated automatically according to the multidimensional information of all the combustion appliances, and the gas device is controlled to deliver the required gas to each of the combustion appliances according to the gas output control parameter corresponding to each of the combustion appliances. In this way, it is capable of improving the accuracy of gas adjustment for the combustion appliances to improve the accuracy of gas allocation, thereby meeting combustion demands of the combustion appliances and ensuring the safety of the gas device, the combustion appliances and other objects and people in the space where the combustion appliances are located. In addition, the gas output control parameter for each of the combustion appliance is corrected in combination with the current connection condition between each of the combustion appliances and the gas device and the control-parameter correcting parameter corresponding to each of the combustion appliances, so that the gas output control parameters all the combustion appliances are corresponding to the current connection condition, which further improves the accuracy of the generation of the corresponding gas output control parameter, thereby improving the allocation and delivery accuracy of the gas.

In an optional implementation, the method may further include the following steps:
a correlation between at least two of all the combustion appliances is collected; and
the control-parameter correcting parameter corresponding to each of the combustion appliances is corrected to obtain the corrected control-parameter correcting parameter corresponding to each of the combustion appliances according to the correlation between the at least two combustion appliances.

For any one of the combustion appliances, the gas output control parameter for the combustion appliance being corrected to obtain the corrected gas output control parameter of the combustion appliance according to the control-parameter correcting parameter corresponding to the combustion appliance includes the following step:
for any one of the combustion appliances, the gas output control parameter for the combustion appliance is corrected to obtain the corrected gas output control parameter of the combustion appliances according to the corrected control-parameter correcting parameter corresponding to the combustion appliance.

In the optional embodiment, the method may be applied in a home scene or in a community scene where a community has many. For the family scene, the associative relationship between at least two combustion appliances can be understood that the functions realized in the current time period are cooperated with each other. For example, a first combustion appliance, which is used for stewing chicken broth is currently frying the chicken and to be added with boiling water, and a second combustion appliance is used for boiling water and providing boiling water for the combustion appliance 1. For the community scene, as long as the combustion appliances belong to a same family, it means that there is a correlation between them.

Evidently, in the optional embodiment, the correlation between the combustion appliances, when determining the gas output control parameter of the combustion appliance, is able to be taken into account to correct the control-parameter correcting parameter, so that the gas output control parameter is corrected, which ensures that the combustion appliances having the correlation are synchronized to get the corresponding amount of gas, thereby improving the accuracy of the synchronization work.

### Third Embodiment

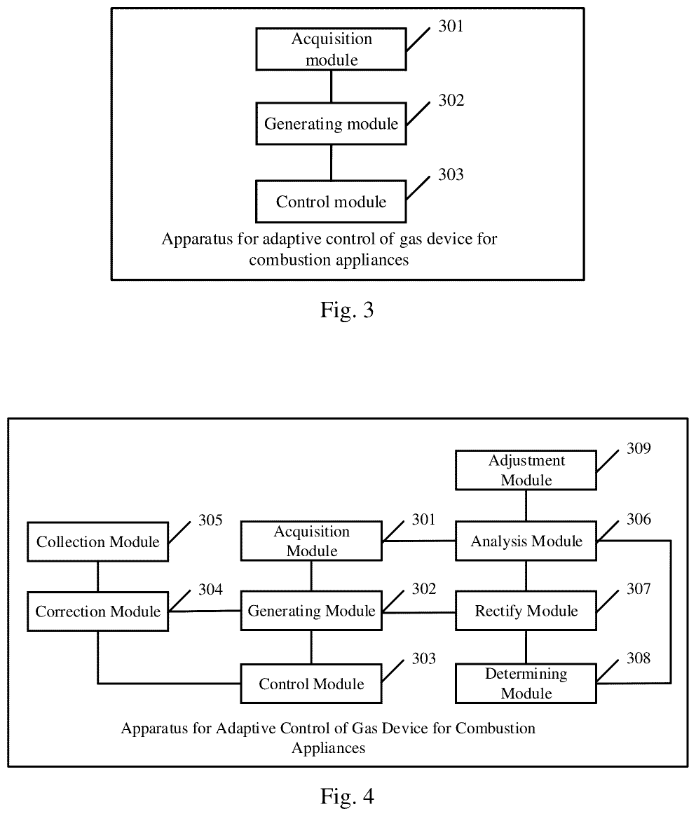

Referring to FIG. 3, FIG. 3 is a schematic structural diagram of an apparatus for adaptive control of a gas device for combustion appliances disclosed in an embodiment of the present disclosure. The apparatus for adaptive control of the gas device for combustion appliances shown in FIG. 3 may be applied in a gas control system. The gas control system includes a control device, combustion appliances and a gas device. The control device is in communication connection with the gas device and each of the combustion appliances, respectively, the gas device is connected to each of the combustion appliances through a gas delivery pipeline, and the gas delivery pipeline corresponding to each of the combustion appliances is configured to deliver gas from the gas device to the corresponding combustion appliance. As shown in FIG. 3, the apparatus for adaptive control of the gas device for combustion appliances may include an acquisition module 301, a generating module 302 and a control module 303.

The acquisition module 301 is configured to acquire multidimensional information corresponding to each of the combustion appliances when it is detected that there are combustion appliances with gas combustion demands in a current time period.

In the embodiment of the present disclosure, optionally, for any one of the combustion appliances, the multidimensional information corresponding to the combustion appliance includes one or more of a type of the combustion appliance, a using requirement of a using object for the combustion appliance at the current time period, a location of the combustion appliance in a current scene, and an ambient parameter in a space where the combustion appliance is located. The using requirement of the using object for the combustion appliance at the current time period includes one or more of a using function, such as a stir-fry function, and a steaming function of a cooking cookware, of the combustion appliance at the current time period, a using gear, such as a first gear, and a second gear, of the using function, and a using duration of the using function. The ambient parameter in the space where the combustion appliance is located includes one or more of ambient humidity, ambient temperature, and air flowing rate. The type of the combustion appliance includes, but is not limited to, one of any type of appliance that requires the use of gas, such as a heating type (e.g., a heater), a cooking type (e.g., a cooking cookware), and a hot water type (e.g., a water heater). It should be noted that the combustion appliances may be understood as none of the appliances being in working condition, or all of the appliances being in working condition, or some of the appliances not being in working condition and some of the appliances being in working condition.

The generating module 302 is configured to generate a gas output control parameter for each of the combustion appliances according to the multidimensional information of all the combustion appliances.

The control module 303 is configured to control the gas device to deliver the required gas to each of the combustion appliances according to the gas output control parameter corresponding to each of the combustion appliances.

Evidently, in the apparatus illustrated in FIG. 3, the multidimensional information corresponding to each of the combustion appliances, such as the type of each of the combustion appliances, the using object for each of the combustion appliances, and the ambient parameter in the space where each of the combustion appliances is located, are acquired automatically when it is detected that there are the combustion appliances with gas combustion demands in a current time period, a gas output control parameter for each of the combustion appliances is generated automatically according to the multidimensional information of all the combustion appliances, and the gas device is controlled to deliver the required gas to each of the combustion appliances according to the gas output control parameter corresponding to each of the combustion appliances. In this way, it is capable of improving the accuracy of gas adjustment for the combustion appliances to improve the accuracy of gas allocation, thereby meeting combustion demands of the combustion appliances and ensuring the safety of the gas device, the combustion appliances and other objects and people in the space where the combustion appliances are located.

In an optional embodiment, as shown in FIG. 3, the acquisition module 301 is further configured to acquire a current connection condition between each of the combustion appliances and the gas device. The current connection condition corresponding to each of the combustion appliances includes at least one of a current gas condition in a gas delivery pipeline and a layout condition of the gas delivery pipeline. The current gas condition corresponding to each of the combustion appliances includes at least one of a current gas flow rate and a current gas pressure. The layout condition corresponding to each of the combustion appliances includes at least one of a pipe diameter of the gas delivery pipeline and a bending condition of the gas delivery pipeline.

The generating module 302 is further configured to generate a control-parameter correcting parameter corresponding to each of the combustion appliances according to the current connection condition corresponding to each of the combustion appliances.

FIG. 4 is a schematic structural diagram of another apparatus for intelligent control of gas devices disclosed in an embodiment of the present disclosure. As shown in FIG. 4, the apparatus further includes a correction module 304.

The correction module 304, for any one of the combustion appliances, is configured to correct the gas output control parameter for the combustion appliance to obtain the corrected gas output control parameter of the combustion appliance according to the control-parameter correcting parameter corresponding to the combustion appliance.

A specific way of the control module 303 controlling the gas device to deliver the required gas to each of the combustion appliances according to the gas output control parameter corresponding to each of the combustion appliances includes:
the gas device is controlled to deliver the required gas to each of the combustion appliances according to the corrected gas output control parameter corresponding to each of the combustion appliances.

Evidently, in the optional embodiment, the gas output control parameter for each of the combustion appliance is corrected in combination with the current connection condition between each of the combustion appliances and the gas device and the control parameter correction parameter corresponding to each of the combustion appliances, so that the gas output control parameters all the combustion appliances are corresponding to the current connection condition, which further improves the accuracy of the generation of the corresponding gas output control parameter, thereby improving the accuracy of the gas allocation and delivery.

In another embodiment, as shown in FIG. 4, the apparatus may further include a collection module 305.

The collection module 305 is configured to collect a correlation between at least two of all the combustion appliances.

The correction module 304 is further configured to correct the control-parameter correcting parameter corresponding to each of the combustion appliances to obtain the corrected control-parameter correcting parameter corresponding to each of the combustion appliances according to the correlation between the at least two combustion appliances.

A specific way of the correction module, for any one of the combustion appliances, correcting the gas output control parameter for the combustion appliance to obtain the corrected gas output control parameter of the combustion appliance according to the control-parameter correcting parameter corresponding to the combustion appliance includes:
for any one of the combustion appliances, the gas output control parameter for the combustion appliance is corrected to obtain the corrected gas output control parameter of the combustion appliances according to the corrected control-parameter correcting parameter corresponding to the combustion appliance.

Evidently, in the optional embodiment, the correlation between the combustion appliances, when determining the gas output control parameter of the combustion appliance, is able to be taken into account to correct the control-parameter correcting parameter, so that the gas output control parameter is corrected, which ensures that the combustion appliances having the correlation are synchronized to get the corresponding amount of gas, thereby improving the accuracy of the synchronization work.

In yet another embodiment, as shown in FIG. 4, a specific way of the generating module 302 generating the gas output control parameter for each of the combustion appliances according to the multidimensional information of all the combustion appliances includes:
gas consumption required for each of the combustion appliances in a unit time is determined according to the multidimensional information of all the combustion appliances;
a gas delivery amount required for each of the combustion appliances in the unit time is analyzed according to the gas consumption required for each of the combustion appliances in the unit time; and
the gas output control parameter for each of the combustion appliances is generated according to the gas delivery amount required for each of the combustion appliances in the unit time.

Evidently, in the optional embodiment, the gas consumption required for each of the combustion appliances in the unit time is determined according to the multidimensional information of each of the combustion appliances, then the gas delivery amount required for each of the combustion appliances in the unit time is determined, and then the corresponding gas output control parameter is generated. Therefore, it is capable of improving the accuracy and reliability of the generation of the gas output control parameter.

In yet another embodiment, as shown in FIG. 4, the acquisition module 301 is further configure to collect a gas supply amount in the unit time from the gas device.

The apparatus further includes an analysis module 306, which is configured to determine whether the gas supply amount of the gas device in the unit time meets gas demands of all the combustion appliances according to the delivery amount required for each of the combustion appliances in the unit time, and to trigger the above operation of the gas output control parameter for each of the combustion appliances being generated according to the gas delivery amount required for each of the combustion appliances in the unit time to be performed if a result is determined to be yes.

As shown in FIG. 4, the apparatus further includes a rectify module 307.

The rectify module 307 is configured to rectify the gas delivery amount required for each of the combustion appliances in the unit time according to the gas supply amount of the gas device in the unit time to obtain the rectified gas delivery amount required for each of the combustion appliances in the unit time if the result is determined to be no.

A specific way of the generating module generating the gas output control parameter for each of the combustion appliances according to the gas delivery amount required for each of the combustion appliances in the unit time includes:
the gas output control parameter for each of the combustion appliances is generated according to the rectified gas delivery amount required for each of the combustion appliances in the unit time.

In the optional embodiment, optionally, the specific way of the rectify module 307 rectifying the gas delivery amount required for each of the combustion appliances in the unit time to obtain the rectified gas delivery amount required for each of the combustion appliances in the unit time according to the gas supply amount of the gas device in the unit time includes: calculating a gas difference between the sum of the gas delivery amounts required for all the combustion appliances and the gas supply amount, calculating a combustion delivery amount ratio between all the combustion appliances according to the gas delivery amounts required for all combustion appliances, and correcting the gas delivery amount required for each of the combustion appliances in the unit of time according to the combustion delivery amount ratio and the gas difference.

Evidently, in the optional embodiment, the corresponding gas output control parameter is generated only if it is determined that the gas supply of the gas device meets the gas demand of all the combustion appliances, and the gas delivery amount required for the combustion appliances is corrected to generate the corresponding gas output control parameter based on the gas supply volume if it is determined that the gas supply of the gas device does not meet the gas demand of all the combustion appliance. Therefore, it is capable of improving the accuracy of the generation of the gas output control parameters corresponding to all the combustion appliances, and even in a case of insufficient gas supply, it is capable of realizing the accurate allocation of gas supply, which is conducive to improving the accuracy of gas supply for each of the combustion appliances and meeting the gas demand of different combustion appliances. In addition, the gas delivery amount required for each combustion appliance is corrected by the gas difference between the sum of the gas delivery amounts required for all combustion appliances and the gas supply amount and the combustion delivery amount ratio between all the combustion appliances, which is capable of improving the allocation accuracy of the gas delivery amount required for all combustion appliances, thereby improving their delivery accuracy.

In yet another embodiment, as shown in FIG. 4, the apparatus may further include a determining module 308 and an adjustment module 309.

The determining module 308 is configured to determine whether there exists in the current time period using requirement information triggered by one or more using objects corresponding to one or more of the all detected combustion appliances for a combustion appliance to be used, and to trigger the analysis module 306 to perform the above operation of analyzing the gas delivery amount required for each of the combustion appliances in the unit time according to the gas consumption required for each of the combustion appliances in the unit time if a result is determined to be no.

The analysis module 306 is further configured to analyze an urgency degree of the gas demand corresponding to each of the one or more combustion appliances in the current time period according to the using requirement information corresponding to each of the one or more combustion appliances if the result is determined to be yes.

The adjustment module 309 is configured to adjust the gas consumption required for each of the one or more combustion appliances in the unit time according to the urgency degree of the gas demand corresponding to each of the one or more combustion appliances, and to trigger the analysis module 306 to perform the above operation of analyzing the gas delivery amount required for each of the one or more combustion appliances in the unit time according to the gas consumption required for each of the one or more combustion appliances in the unit time.

In the optional embodiment, for any one of the combustion appliances, the corresponding using demand information may be triggered by a voice input by the corresponding using object, or may be triggered by a text input by the corresponding using object, or may be triggered by a combination of both. Further optionally, for the combustion appliance with a higher urgency degree of the gas demand, the gas consumption required for it in the unit time, on the premise of ensuring its safety, is increased, and the gas delivery amount required for it in the unit time is increased correspondingly, or priority is given to delivering gas to it.

Evidently, in the optional embodiment, whether the using requirement information triggered by the using object of the corresponding combustion appliance is received, and then the gas delivery amount required for the combustion appliance in the unit time is continuing to be analyzed if not, otherwise the using requirement information triggered by the using object of the combustion appliance is analyzed and the gas delivery amount required for the combustion appliance is adjusted according to the analyzed urgency degree of the gas demand. In this way, it is capable of meeting the gas demand of the corresponding using object while improving the accuracy of determining the gas consumption required for each of the combustion appliances while, thus improving the user's gas experience.

The determining module is configured to determine whether there exists in the current time period using requirement information triggered by one or more using objects corresponding to one or more of the all detected combustion appliances for a combustion appliance to be used, and to trigger the above operation of analyzing, according to the gas consumption required for each of the combustion appliances in the unit time, the gas delivery amount required for each of the combustion appliances in the unit time if a result is determined to be no.

The adjustment module 309 is further configured to perform the following steps: acquiring the historical gas consumption for each of the combustion appliances in a historical time period on every day of the past multiple days that corresponds to, i.e., is the same as or overlaps with, the current time period if the gas using period type to which the current time period belongs is configured to indicate a time period in which the gas consumption of them is greater than or equal to the preset gas consumption; calculating, for any one of the combustion appliances, the sum of its corresponding historical gas consumption for each day of the past multiple days, dividing the sum of the historical gas consumption by the corresponding days to obtain the historical average gas consumption, calculating a consumption difference between the historical average gas consumption and the preset gas consumption; and adjusting the gas consumption required for each of the combustion appliances in the unit time according to the consumption difference corresponding to each of the combustion appliances, and triggering the analysis module 306 to perform the operation of analyzing, according to the gas consumption required for each of the combustion appliances in the unit time, the gas delivery amount required for each of the combustion appliances in the unit time.

Evidently, in the optional embodiment, the aforementioned gas consumption analyzed according to the multidimensional information of the combustion appliance is adjusted automatically by acquiring its historical gas consumption in the time period on every day of the past multiple days that corresponding to the current time period if it is determined that the corresponding using requirement information is not detected in the current time period, so that it is capable of further improving the analysis accuracy of the gas consumption required for each of the combustion appliances, thereby facilitating further improving the analysis accuracy of the gas delivery amount required for each of the combustion appliances, which in turn is conducive to improving the accuracy of the generation of the corresponding gas output control parameter, and improving the allocation and delivery accuracy of the gas.

### Fourth Embodiment

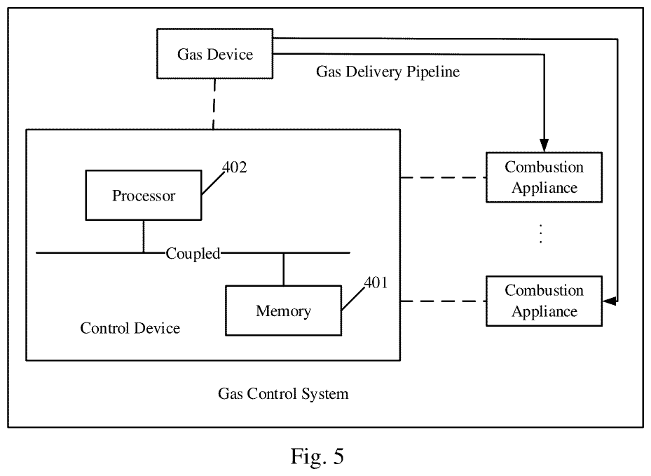

Referring to FIG. 5, FIG. 5 is a schematic structural diagram of a gas control system disclosed in an embodiment of the present disclosure. As shown in FIG. 5, the gas control system includes a control device, a gas device and combustion appliances. The control device is in communication connection with the gas device and each of the combustion appliances, respectively, the gas device is connected to each of the combustion appliances through a gas delivery pipeline, and the gas delivery pipeline corresponding to each of the combustion appliances is configured to deliver gas from the gas device to the corresponding combustion appliance, The control device may include a memory 401 and a processor 402.

The memory 401 is memorized with an executable code.

The processor 402 is coupled with the memory.

The processor 402 invokes the executable code memorized in the memory 401 to perform the steps in the method for adaptive control of the gas device for combustion appliances described in the first embodiment or the second embodiment.

### Fifth Embodiment

Disclosed in the present embodiment of the disclosure is a non-transitory computer readable memory medium. The non-transitory computer readable memory medium memorizes computer instructions. The computer instructions are configured to cause steps in the method for adaptive control of the gas device for combustion appliance described in the first embodiment or the second embodiment of the present disclosure to be performed when invoked.

### Sixth Embodiment

Disclosed in the present embodiment of the disclosure is a computer program product. The computer program product includes a non-transitory computer memory medium memorized with a computer program. The computer program may be operated to enable the computer to perform steps in the method for adaptive control of the gas device for combustion appliances described in the first embodiment or the second embodiment.

The aforementioned described embodiment of the apparatus is only illustrative. The modules described as separate components may or may not be physically separated, and the modules used as components for display may or may not be physical modules, that is, they may be located in the same place or may be distributed to a plurality of network modules. Some or all these modules may be selected according to practical demands to achieve the purpose of the solution of the present embodiment. It may be understood and performed by a person of ordinary skill in the art without inventive effort.

With the specific description of the above embodiments, it is clear to those skilled in the art that the various implementations may be implemented with the aid of software plus the necessary common hardware platform, and admittedly, with the aid of hardware. Based on such an understanding, the above technical solutions that essentially or contribute to the prior art may be embodied in the form of a software product which may be memorized in a non-transitory computer readable memory medium, and the non-transitory memory readable medium includes Read-Only Memory, Random Access Memory, Programmable Read-only Memory, Erasable Programmable Read Only Memory, One-time Programmable Read-Only Memory, Electrically-Erasable Programmable Read-Only Memory, Compact Disc Read-Only Memory, other Compact Disc Memory, Disk Memory, Tape Memory or any other non-transitory computer-readable medium that may be used to carry or memorize data.

Finally, it should be noted that the method, apparatus and system for adaptive control of the gas device for combustion appliances disclosed in the embodiments of the present disclosure are only preferred embodiments of the present disclosure, and are only used to illustrate the technical solutions of the present disclosure, but not to limit them. Despite the detailed description of the disclosure with reference to the aforementioned embodiments, it should be understood, by those skilled in the art, that the technical solutions recorded in the aforementioned embodiments may still be modified, or equivalent substitutions for some of the technical features thereof may be made, but the essence of the corresponding technical solutions of these modifications or substitutions is without departing from the spirit and scope of the technical solutions of the various embodiments of the disclosure.

1. A method for adaptive control of a gas device for combustion appliances, wherein the method is applied in a gas control system, the gas control system comprising at least a control device, and the method comprises:
acquiring, when it is detected that there are combustion appliances with gas combustion demands in a current time period, multidimensional information corresponding to each of the combustion appliances;
generating, according to the multidimensional information of all the combustion appliances, a gas output control parameter for each of the combustion appliances; and
controlling, according to the gas output control parameter corresponding to each of the combustion appliances, the gas device to deliver required gas to each of the combustion appliances.

2. The method for adaptive control of the gas device for combustion appliances according to claim 1, the method further comprising:
acquiring a current connection condition between each of the combustion appliances and the gas device, the current connection condition corresponding to each of the combustion appliances comprising at least one of a current gas condition in a gas delivery pipeline and a layout condition of the gas delivery pipeline, the current gas condition corresponding to each of the combustion appliances comprising at least one of a current gas flow rate and a current gas pressure, and the layout condition corresponding to each of the combustion appliances comprising at least one of a pipe diameter of the gas delivery pipeline and a bending condition of the gas delivery pipeline;
generating, according to the current connection condition corresponding to each of the combustion appliances, a control-parameter correcting parameter corresponding to each of the combustion appliances; and
correcting, for any one of the combustion appliances, the gas output control parameter for the combustion appliance to obtain the corrected gas output control parameter of the combustion appliance according to the control-parameter correcting parameter corresponding to the combustion appliance,
wherein the controlling, according to the gas output control parameter corresponding to each of the combustion appliances, the gas device to deliver the required gas to each of the combustion appliances comprises:
controlling, according to the corrected gas output control parameter corresponding to each of the combustion appliances, the gas device to deliver the required gas to each of the combustion appliances.

3. The method for adaptive control of the gas device for combustion appliances according to claim 2, the method further comprising:
collecting a correlation between at least two of all the combustion appliances; and
correcting, according to the correlation between the at least two combustion appliances, the control-parameter correcting parameter corresponding to each of the combustion appliances to obtain the corrected control-parameter correcting parameter corresponding to each of the combustion appliances,
wherein the correcting, for any one of the combustion appliances, the gas output control parameter for the combustion appliance to obtain the corrected gas output control parameter of the combustion appliance according to the control-parameter correcting parameter corresponding to the combustion appliance comprises:
correcting, for any one of the combustion appliances, the gas output control parameter for the combustion appliance to obtain the corrected gas output control parameter of the combustion appliances according to the corrected control-parameter correcting parameter corresponding to the combustion appliance.

4. The method for adaptive control of the gas device for combustion appliances according to claim 1, wherein the generating, according to the multidimensional information of all the combustion appliances, the gas output control parameter for each of the combustion appliances comprises:
determining, according to the multidimensional information of all the combustion appliances, gas consumption required for each of the combustion appliances in a unit time;
analyzing, according to the gas consumption required for each of the combustion appliances in the unit time, a gas delivery amount required for each of the combustion appliances in the unit time; and
generating, according to the gas delivery amount required for each of the combustion appliances in the unit time, the gas output control parameter for each of the combustion appliances.

5. The method for adaptive control of the gas device for combustion appliances according to claim 4, the method further comprising:
collecting, from the gas device, a gas supply amount in the unit time;
determining, according to the delivery amount required for each of the combustion appliances in the unit time, whether the gas supply amount of the gas device in the unit time meets gas demands of all the combustion appliances;
triggering, if a result is determined to be yes, operation of generating, according to the gas delivery amount required for each of the combustion appliances in the unit time, the gas output control parameter for each of the combustion appliances to be performed; and
rectifying, if the result is determined to be no, the gas delivery amount required for each of the combustion appliances in the unit time to obtain the rectified gas delivery amount required for each of the combustion appliances in the unit time according to the gas supply amount of the gas device in the unit time,
wherein the generating, according to the gas delivery amount required for each of the combustion appliances in the unit time, the gas output control parameter for each of the combustion appliances comprises:
generating, according to the rectified gas delivery amount required for each of the combustion appliances in the unit time, the gas output control parameter for each of the combustion appliances.

6. The method for adaptive control of the gas device for combustion appliances according to claim 4, wherein the method further comprises:
determining whether there exists in the current time period using requirement information triggered by one or more using objects corresponding to one or more of the all detected combustion appliances for a combustion appliance to be used;
triggering, if a result is determined to be no, operation of analyzing, according to the gas consumption required for each of the combustion appliances in the unit time, the gas delivery amount required for each of the combustion appliances in the unit time to be performed;
analyzing, if the result is determined to be yes, an urgency degree of the gas demand corresponding to each of the one or more combustion appliances in the current time period according to the using requirement information corresponding to each of the one or more combustion appliances;
adjusting, according to the urgency degree of the gas demand corresponding to each of the one or more combustion appliances, the amount of gas required to be used by each of the one or more combustion appliances in the unit time; and
triggering the operation of analyzing, according to the gas consumption required for each of the one or more combustion appliances in the unit time, the gas delivery amount required for each of the one or more combustion appliances in the unit time to be performed.

7. The method for adaptive control of the gas device for combustion appliances according to claim 4, wherein for any one of the combustion appliances, the multidimensional information corresponding to the combustion appliance comprises one or more of a type of the combustion appliance, a using requirement of a using object for the combustion appliance at the current time period, a location of the combustion appliance in a current scene, and an ambient parameter in a space where the combustion appliance is located;
the using requirement of the using object for the combustion appliance at the current time period comprises one or more of a using function of the combustion appliance at the current time period, a using gear of the using function, and a using duration of the using function; and
the ambient parameter in the space where the combustion appliance is located comprises one or more of ambient humidity, ambient temperature, and air flowing rate.

8. A gas control system, comprising at least a control device, wherein the control device comprises:
a memory, memorized with an executable code; and
a processor, coupled with the memory;
wherein the processor invokes the executable code memorized in the memory to perform a method for adaptive control of the gas device for combustion appliances, and the method comprises:
acquiring, when it is detected that there are combustion appliances with gas combustion demands in a current time period, multidimensional information corresponding to each of the combustion appliances;
generating, according to the multidimensional information of all the combustion appliances, a gas output control parameter for each of the combustion appliances; and
controlling, according to the gas output control parameter corresponding to each of the combustion appliances, the gas device to deliver required gas to each of the combustion appliances.

9. The gas control system according to claim 8, the method further comprising:
acquiring a current connection condition between each of the combustion appliances and the gas device, the current connection condition corresponding to each of the combustion appliances comprising at least one of a current gas condition in a gas delivery pipeline and a layout condition of the gas delivery pipeline, the current gas condition corresponding to each of the combustion appliances comprising at least one of a current gas flow rate and a current gas pressure, and the layout condition corresponding to each of the combustion appliances comprising at least one of a pipe diameter of the gas delivery pipeline and a bending condition of the gas delivery pipeline;
generating, according to the current connection condition corresponding to each of the combustion appliances, a control-parameter correcting parameter corresponding to each of the combustion appliances; and
correcting, for any one of the combustion appliances, the gas output control parameter for the combustion appliance to obtain the corrected gas output control parameter of the combustion appliance according to the control-parameter correcting parameter corresponding to the combustion appliance,
wherein the controlling, according to the gas output control parameter corresponding to each of the combustion appliances, the gas device to deliver the required gas to each of the combustion appliances comprises:
controlling, according to the corrected gas output control parameter corresponding to each of the combustion appliances, the gas device to deliver the required gas to each of the combustion appliances.

10. The gas control system according to claim 9, the method further comprising:
collecting a correlation between at least two of all the combustion appliances; and
correcting, according to the correlation between the at least two combustion appliances, the control-parameter correcting parameter corresponding to each of the combustion appliances to obtain the corrected control-parameter correcting parameter corresponding to each of the combustion appliances,
wherein, the correcting, for any one of the combustion appliances, the gas output control parameter for the combustion appliance to obtain the corrected gas output control parameter of the combustion appliance according to the control-parameter correcting parameter corresponding to the combustion appliance comprises:
correcting, for any one of the combustion appliances, the gas output control parameter for the combustion appliance to obtain the corrected gas output control parameter of the combustion appliances according to the corrected control-parameter correcting parameter corresponding to the combustion appliance.

11. The gas control system according to claim 8, wherein the generating, according to the multidimensional information of all the combustion appliances, the gas output control parameter for each of the combustion appliances comprises:
determining, according to the multidimensional information of all the combustion appliances, gas consumption required for each of the combustion appliances in a unit time;
analyzing, according to the gas consumption required for each of the combustion appliances in the unit time, a gas delivery amount required for each of the combustion appliances in the unit time; and
generating, according to the gas delivery amount required for each of the combustion appliances in the unit time, the gas output control parameter for each of the combustion appliances.

12. The gas control system according to claim 11, the method further comprising:
collecting, from the gas device, a gas supply amount in the unit time;
determining, according to the delivery amount required for each of the combustion appliances in the unit time, whether the gas supply amount of the gas device in the unit time meets gas demands of all the combustion appliances;
triggering, if a result is determined to be yes, operation of generating, according to the gas delivery amount required for each of the combustion appliances in the unit time, the gas output control parameter for each of the combustion appliances to be performed; and
rectifying, if the result is determined to be no, the gas delivery amount required for each of the combustion appliances in the unit time to obtain the rectified gas delivery amount required for each of the combustion appliances in the unit time according to the gas supply amount of the gas device in the unit time,
wherein the generating, according to the gas delivery amount required for each of the combustion appliances in the unit time, the gas output control parameter for each of the combustion appliances comprises:
generating, according to the rectified gas delivery amount required for each of the combustion appliances in the unit time, the gas output control parameter for each of the combustion appliances.

13. The gas control system according to claim 11, wherein the method further comprises:
determining whether there exists in the current time period using requirement information triggered by one or more using objects corresponding to one or more of the all detected combustion appliances for a combustion appliance to be used;
triggering, if a result is determined to be no, operation of analyzing, according to the gas consumption required for each of the combustion appliances in the unit time, the gas delivery amount required for each of the combustion appliances in the unit time to be performed;
analyzing, if the result is determined to be yes, an urgency degree of the gas demand corresponding to each of the one or more combustion appliances in the current time period according to the using requirement information corresponding to each of the one or more combustion appliances;
adjusting, according to the urgency degree of the gas demand corresponding to each of the one or more combustion appliances, the amount of gas required to be used by each of the one or more combustion appliances in the unit time; and
triggering the operation of analyzing, according to the gas consumption required for each of the one or more combustion appliances in the unit time, the gas delivery amount required for each of the one or more combustion appliances in the unit time to be performed.

14. A non-transitory computer readable memory medium, wherein the non-transitory computer readable memory medium memorizes computer instructions, the computer instructions, when invoked, are configured to cause a method for adaptive control of a gas device for combustion appliances to be performed, and the method comprises:
acquiring, when it is detected that there are combustion appliances with gas combustion demands in a current time period, multidimensional information corresponding to each of the combustion appliances;
generating, according to the multidimensional information of all the combustion appliances, a gas output control parameter for each of the combustion appliances; and
controlling, according to the gas output control parameter corresponding to each of the combustion appliances, the gas device to deliver required gas to each of the combustion appliances.

15. The non-transitory computer readable memory medium according to claim 14, the method further comprising:
acquiring a current connection condition between each of the combustion appliances and the gas device, the current connection condition corresponding to each of the combustion appliances comprising at least one of a current gas condition in a gas delivery pipeline and a layout condition of the gas delivery pipeline, the current gas condition corresponding to each of the combustion appliances comprising at least one of a current gas flow rate and a current gas pressure, and the layout condition corresponding to each of the combustion appliances comprising at least one of a pipe diameter of the gas delivery pipeline and a bending condition of the gas delivery pipeline;
generating, according to the current connection condition corresponding to each of the combustion appliances, a control-parameter correcting parameter corresponding to each of the combustion appliances; and
correcting, for any one of the combustion appliances, the gas output control parameter for the combustion appliance to obtain the corrected gas output control parameter of the combustion appliance according to the control-parameter correcting parameter corresponding to the combustion appliance,
wherein the controlling, according to the gas output control parameter corresponding to each of the combustion appliances, the gas device to deliver the required gas to each of the combustion appliances comprises:
controlling, according to the corrected gas output control parameter corresponding to each of the combustion appliances, the gas device to deliver the required gas to each of the combustion appliances.

16. The non-transitory computer readable memory medium according to claim 15, the method further comprising:
collecting a correlation between at least two of all the combustion appliances; and
correcting, according to the correlation between the at least two combustion appliances, the control-parameter correcting parameter corresponding to each of the combustion appliances to obtain the corrected control-parameter correcting parameter corresponding to each of the combustion appliances,
wherein, the correcting, for any one of the combustion appliances, the gas output control parameter for the combustion appliance to obtain the corrected gas output control parameter of the combustion appliance according to the control-parameter correcting parameter corresponding to the combustion appliance comprises:
correcting, for any one of the combustion appliances, the gas output control parameter for the combustion appliance to obtain the corrected gas output control parameter of the combustion appliances according to the corrected control-parameter correcting parameter corresponding to the combustion appliance.

17. The non-transitory computer readable memory medium according to claim 14, wherein the generating, according to the multidimensional information of all the combustion appliances, the gas output control parameter for each of the combustion appliances comprises:
determining, according to the multidimensional information of all the combustion appliances, gas consumption required for each of the combustion appliances in a unit time;
analyzing, according to the gas consumption required for each of the combustion appliances in the unit time, a gas delivery amount required for each of the combustion appliances in the unit time; and
generating, according to the gas delivery amount required for each of the combustion appliances in the unit time, the gas output control parameter for each of the combustion appliances.

18. The non-transitory computer readable memory medium according to claim 17, the method further comprising:
collecting, from the gas device, a gas supply amount in the unit time;
determining, according to the delivery amount required for each of the combustion appliances in the unit time, whether the gas supply amount of the gas device in the unit time meets gas demands of all the combustion appliances;
triggering, if a result is determined to be yes, operation of generating, according to the gas delivery amount required for each of the combustion appliances in the unit time, the gas output control parameter for each of the combustion appliances to be performed; and
rectifying, if the result is determined to be no, the gas delivery amount required for each of the combustion appliances in the unit time to obtain the rectified gas delivery amount required for each of the combustion appliances in the unit time according to the gas supply amount of the gas device in the unit time,
wherein the generating, according to the gas delivery amount required for each of the combustion appliances in the unit time, the gas output control parameter for each of the combustion appliances comprises:
generating, according to the rectified gas delivery amount required for each of the combustion appliances in the unit time, the gas output control parameter for each of the combustion appliances.

19. The non-transitory computer readable memory medium according to claim 17, wherein the method further comprises:
determining whether there exists in the current time period using requirement information triggered by one or more using objects corresponding to one or more of the all detected combustion appliances for a combustion appliance to be used;
triggering, if a result is determined to be no, operation of analyzing, according to the gas consumption required for each of the combustion appliances in the unit time, the gas delivery amount required for each of the combustion appliances in the unit time to be performed;
analyzing, if the result is determined to be yes, an urgency degree of the gas demand corresponding to each of the one or more combustion appliances in the current time period according to the using requirement information corresponding to each of the one or more combustion appliances;
adjusting, according to the urgency degree of the gas demand corresponding to each of the one or more combustion appliances, the amount of gas required to be used by each of the one or more combustion appliances in the unit time; and
triggering the operation of analyzing, according to the gas consumption required for each of the one or more combustion appliances in the unit time, the gas delivery amount required for each of the one or more combustion appliances in the unit time to be performed.

20. The non-transitory computer readable memory medium according to claim 17, wherein for any one of the combustion appliances, the multidimensional information corresponding to the combustion appliance comprises one or more of a type of the combustion appliance, a using requirement of a using object for the combustion appliance at the current time period, a location of the combustion appliance in a current scene, and an ambient parameter in a space where the combustion appliance is located;
the using requirement of the using object for the combustion appliance at the current time period comprises one or more of a using function of the combustion appliance at the current time period, a using gear of the using function, and a using duration of the using function; and
the ambient parameter in the space where the combustion appliance is located comprises one or more of ambient humidity, ambient temperature, and air flowing rate.
